(19) United States
(12) Patent Application Publication
(10) Pub. No.: US 2012/0070743 A1
(43) Pub. Date: Mar. 22, 2012

(54) POSITIVE ACTIVE MATERIAL, METHOD OF PREPARING THE SAME, AND LITHIUM BATTERY INCLUDING THE POSITIVE ACTIVE MATERIAL

(75) Inventors: Seon-Young Kwon, Yongin-si (KR); Do-Hyung Park, Yongin-si (KR); Min-Han Kim, Yongin-si (KR); Ji-Hyun Kim, Yongin-si (KR); Jeong-Seop Lee, Yongin-si (KR); Chang-Hyuk Kim, Yongin-si (KR); Yoon-Chang Kim, Yongin-si (KR)

(73) Assignee: SAMSUNG SDI CO., LTD., Yongin-si (KR)

(21) Appl. No.: 13/211,084

(22) Filed: Aug. 16, 2011

(30) Foreign Application Priority Data
Sep. 20, 2010 (KR) 10-2010-0092505

(51) Int. Cl. H01M 4/505; H01B 1/02; H01M 4/525

(52) U.S. Cl. 429/223; 429/224; 252/519.15

(57) ABSTRACT

A positive active material and a method of preparing a positive active material, and a lithium battery including the positive active material. In one embodiment, the positive active material includes single particles each being represented by Formula 1:

Liₓ(NiₚCo_{q}Mnᵣ)O_{y},

where, in Formula 1, 0.95≦x≦1.05, 0<p<1, 0<q<1, 0<r<1, p+q+r=1 and 0<y≦2.025.

### CLAIM OF PRIORITY

This application makes reference to, incorporates the same herein, and claims all benefits accruing under 35 U.S.C. §119 from an application earlier filed in the Korean Intellectual Property Office on 20 Sep. 2010 and there duly assigned Serial No. 10-2010-0092505.

### BACKGROUND OF THE INVENTION

1. Field of the Invention

One or more features of the present invention relate to a positive active material, a method of preparing the same, and a lithium battery including the positive active material.

2. Description of the Related Art

Recently, portable electronic devices for information communication, such as personal data assistants (PDAs), mobile phones, and laptop computers, and electric bicycles, electric vehicles, and the like increasingly demand repeatedly rechargeable secondary batteries used as their power source.

Lithium batteries, which are rechargeable, attract most attention because of their high voltage and high energy density.

Lithium batteries include negative and positive electrodes, each including an active material that allows intercalation and deintercalation of lithium ions, and an organic electrolyte or a polymer electrolyte filling a gap disposed between the negative and positive electrodes. Lithium batteries produce electrical energy from redox reactions taking place as lithium ions are intercalated into or deintercalated from the positive and negative electrodes.

The above information disclosed in this Background section is only for enhancement of understanding of the background of the invention and therefore it may contain information that does not form the prior art that is already known in this country to a person of ordinary skill in the art.

### SUMMARY OF THE INVENTION

One or more features of the present invention include a positive active material that has good electrochemical characteristics and that does not substantially induce side reactions with an electrolyte.

One or more features of the present invention include a method of preparing the positive active material, and a lithium battery including the positive active material.

In accordance with one or more features of the present invention, a positive active material may be represented by Formula 1 below, and the positive active material may be in the form of single particles:

Liₓ(NiₚCo_{q}Mnᵣ)O_{y} Formula 1

wherein in Formula 1 above, 0.95≦x≦1.05, 0<p<1, 0<q<1, 0<r<1, p+q+r=1 and 0<y≦2.025.

The positive active material may have an average particle diameter (D₅₀) of about 5 μm to about 10 μm. The “average particle diameter (D₅₀)” refers to a cumulative particle diameter at 50% of the cumulative diameter distributions in a curve representing the distribution of the particle diameters.

The positive active material may have a specific surface area of about 0.23 m²/g or less.

Formula 1 may be satisfied when x=1, p=0.5, q=0.2, r=0.3, and y=2, when x=1.05, p=0.6, q=0.2, r=0.2, and y=2, or when x=1.03, p=0.5, q=0.2, r=0.3, and y=2.

In accordance with one or more features of the present invention, a method of preparing a positive active material may include steps of obtaining a first mixture by mixing a Ni-containing material, a Co-containing material, and a Mn-containing material with a first solvent; obtaining a second mixture by removing the first solvent from the first mixture and adding a Li-containing material to the first solvent; and thermally treating the second mixture.

The Ni-containing material may include at least one compound selected from the group consisting of nickel oxides, nickel hydroxides, nickel carbonates, nickel nitrides, nickel sulfides, nickel halides, and carboxylic acid nickel salts. The Co-containing material may include at least one compound selected from the group consisting of cobalt oxides, cobalt hydroxides, cobalt halides, and carboxylic acid cobalt salts. The Mn-containing compound may include at least one compound selected from the group consisting of manganese oxides, manganese carbonates, manganese nitrides, manganese sulfides, manganese halides, and carboxylic acid manganese salts.

The first solvent may include an alcohol-based solvent.

The thermal treating of the second mixture may be performed ata temperature of about 800° C. to about 1000° C.

The thermal treating of the second mixture may be performed for a duration of about 10 hours to about 15 hours.

In accordance with one or more features of the present invention, a method of preparing a positive active material may include steps of obtaining a third mixture by mixing a nickel (Ni)-containing material, a cobalt (Co)-containing material, a manganese (Mn)-containing material, and a lithium (Li)-containing material with a second solvent; obtaining a fourth mixture by removing the second solvent from the third mixture; and thermally treating the fourth mixture.

The same kinds of Ni-containing materials, Co-containing materials, and Mn-containing compounds as those listed above may be used.

The second solvent may include an alcohol-based solvent.

The thermal treating of the fourth mixture may be performed at a temperature of about 800° C. to about 1000° C.

The thermally treating of the fourth mixture may be performed for a duration of about 10 hours to about 15 hours.

In accordance with one or more features of the present invention, a lithium battery may include a positive electrode including the positive active material described above, represented by Formula 1; a negative electrode; and an electrolyte.

Additional aspects will be set forth in part in the description which follows and, in part, will be apparent from the description, or may be learned by practice of the presented embodiments.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded oblique view of a lithium cell according to an embodiment of the present invention;

FIG. 2 is a scanning electron microscopic (SEM) image (50× magnification) of a positive active material of Example 1;

FIG. 3 is a SEM image (10,000× magnification) of a positive active material of Example 1;

FIG. 4 is a SEM image (50× magnification) of a positive active material of Comparative Example 1;

FIG. 5 is a SEM image (10,000× magnification) of a positive active material of Comparative Example 1;

FIG. 6 is a flow chart showing the method of manufacturing the positive active material in accordance with an embodiment of the present invention; and

FIG. 7 is a flow chart showing the method of manufacturing the positive active material in accordance with another embodiment of the present invention.

### DETAILED DESCRIPTION OF THE INVENTION

Certain exemplary embodiments of the present invention will now be described with reference to the accompanying drawings, in which like reference numerals refer to like elements throughout. It will be however understood that the presently described embodiments may be modified in many different ways, and are therefore not to be construed as limiting the scope of the present invention.

According to embodiments, a positive active material is represented by Formula 1 below:

Liₓ(NiₚCo_{q}Mnᵣ)O_{y} Formula 1

In Formula 1 above, 0.95≦x≦1.05, 0<p<1, 0<q<1, 0<r<1, p+q+r=1, and 0<y≦2.025.

For example, Formula 1 above may be satisfied when 1≦x≦1.05, 0.5≦p≦0.6, 0.2≦q≦0.3, and 0.1≦r≦0.3.

In Formula 1 above, for example, x=1, p=0.5, q=0.2, r=0.3, and y=2. For another example, x=1.05, p=0.6, q=0.2, r=0.2, and y=2. For another example, x=1.03, p=0.5, q=0.2, r=0.3, and y=2.

For example, if in Formula 1 above, x=1, p=0.5, q=0.2, r=0.3, and y=2, the positive active material may form a layer structure identical to LiCoO₂ and may have a superlattice structure, so that the positive active material may have good electrochemical characteristics and may be stable during operation at high voltages.

The positive active material may be in the form of single particles. In one embodiment, each of particles represented by Formula 1 is disposed in an individual form and has a distinct boundary. The term “single particles” is used herein as being distinct from “secondary particles” indicating agglomerates of a plurality of primary particles having specific particle diameters. The positive active material in single particles means that the positive active material is present in the form of individual particles with distinct boundaries, which may be seen by using a scanning electron microscope (SEM), rather than being agglomerated together.

That is to say, the positive active material may be represented by Formula 1 above, and is in the form of single particles. This positive active material should be distinguished from a material of Formula 1 above that is in the form of secondary particles (i.e., an agglomerate of multiple primary particles having specific particle diameter).

For example, a material of Formula 1 in the form of secondary particles may be obtained by preparing a precursor (in the form of secondary particles) represented by Liₓ(NiₚCo_{q}Mnᵣ)(OH)₂, mixing the precursor with a Li-containing material, and thermally treating the mixture. This material of Formula 1 in the form of secondary particles has very rough surfaces.

When the positive active material represented by Formula 1 in the form of secondary particles is used in a positive active material layer, such positive active material represented by Formula 1 above in the form of secondary particles may be broken during roll-pressing, which is applied to form the active positive material layer. In addition, in a lithium battery including a positive electrode containing the material represented by Formula 1 in the form of secondary particles as a positive active material, the surface area of the material represented by Formula 1 in the form of secondary particles is large enough to induce side reactions with an electrolyte in the lithium battery, so that the electrical characteristics of the lithium battery may deteriorate.

On the other hand, the positive active material represented by Formula 1 in the form of single particles has substantially smooth surfaces, so that such positive active material may substantially not be broken during roll-pressing, which is performed when forming a positive active material layer. In addition, the positive active material represented by Formula 1 in the form of single particles is unlikely to be involved in side reactions with the electrolyte, so that the characteristics of the lithium battery including the positive active material may not deteriorate.

Hereinafter, the term “positive active material” refers to the positive active material represented by Formula 1 in the form of single particles unless otherwise stated.

The positive active material may have an average particle diameter (D₅₀) of about 5 μm to about 10 μm. For example, the positive active material may have an average particle diameter (D₅₀) of about 6 μm to about 9 μm. The term “average particle diameter (D₅₀)” refers to a cumulative particle diameter at 50% of the cumulative diameter distributions in a particle diameter distribution curve.

When the average particle diameter of the positive active material is within the above mentioned ranges, lithium ions may be substantially prevented from being irreversibly intercalated or deintercalated due to the decomposition of the surfaces of the positive active material. In addition, side reactions between the positive active material and the electrolyte may be suppressed. Therefore, a lithium battery having good output characteristics may be achieved with the positive active material.

The average particle diameter (D₅₀) of the positive active material may be measured from an approximate 1,000×-magnification of a SEM image. Approximately 30 to 50 particle diameters are randomly selected from the magnification of the SEM image to measure the average particle diameter (D₅₀) of the positive active material.

The positive active material may have a specific surface area of about 0.23 m²/g or less. For example, the positive active material may have a specific surface area of about 0.22 m²/g to about 0.20 m²/g.

When the specific surface area of the positive active material is within these ranges, side reactions between the positive active material and the electrolyte may be effectively suppressed, so that a lithium battery having good output characteristics may be achieved.

The specific surface area of the positive active material may be measured using a known Brunauer-Emmett-Teller (B.E.T.) surface area analyzer.

The positive active material may have a better particle density (g/cc) than secondary particles, due to it being in the form of single particles. For example, the positive active material in the form of single particles may include substantially no pores on the surface and/or inside thereof. Conversely, in the positive active material in the form of secondary particles are agglomerated from a plurality of primary particles having specific particle diameters and thus such positive active material in the form of secondary particles may include relatively more pores between adjacent primary particles. Therefore, the positive active material in the form of single particles may be used in a positive electrode of a lithium battery to provide good capacity characteristics.

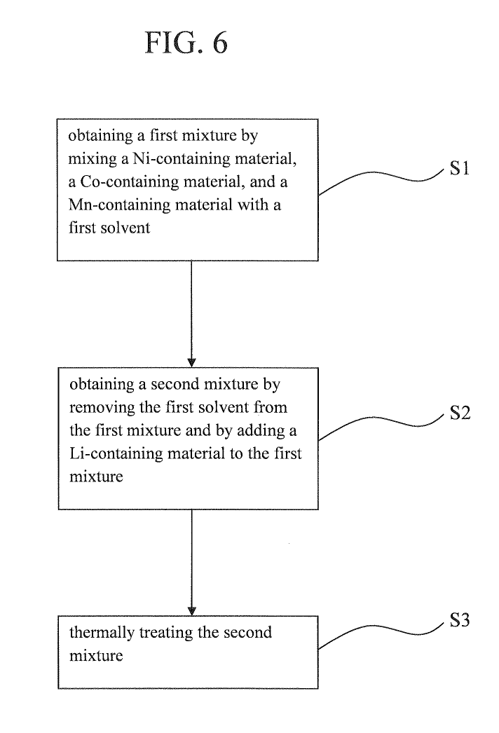

As shown in FIG. 6, according to embodiments of the present invention, a method of preparing the positive active material includes steps of (S1) obtaining a first mixture by mixing a Ni-containing material, a Co-containing material, and a Mn-containing material with a first solvent; (S2) obtaining a second mixture by removing the first solvent from the first mixture and by adding a Li-containing material to the first mixture; and (S3) thermally treating the second mixture.

Examples of the Ni-containing material include: nickel nitrides, such as NiO and NiO₂; nickel hydroxides, such as Ni(OH)₂, NiOOH, and 2Ni(OH)₂.4H₂O; nickel carbonates; nickel nitrides, such as Ni(NO₃)₂.6H₂O; nickel sulfides, such as NiSO₄ and NiSO₄.6H₂O; nickel halides; and carboxylic acid nickel salts, such as nickel acetates and NiC₂O₄.2H₂O. A combination of at least two of these examples may also be used.

Examples of the Co-containing material include: cobalt oxides, such as CoO, CO₂O₃, and Co₃O₄; cobalt hydroxides, such as Co(OH)₂; cobalt halides; and carboxylic acid cobalt salts, such as Co(OCOCH₃)₂.4H₂O. A combination of at least two of these examples may also be used.

Examples of the Mn-containing material include: manganese oxides, such as Mn₂O₃, MnO₂, and Mn₃O₄; manganese carbonates; manganese nitrides, such as Mn(NO₃)₂; manganese sulfides, such as MnSO₄; manganese halides; and carboxylic acid manganese salts, such as manganese acetate and manganese citrate. A combination of at least two of these examples may also be used.

The Ni-containing material, the Co-containing material, and the Mn-containing material may each independently have an average diameter (D₅₀) of about 10 μm or less. For example, the Ni-containing material, the Co-containing material, and the Mn-containing material may each independently have an average diameter (D₅₀) of about 1 μm to about 10 μm. When the average particle diameters of the Ni-containing material, the Co-containing material, and the Mn-containing material are within these ranges, the positive active material may have good electrical characteristics.

An example of the first solvent may be a solvent that is uniformly miscible with the Ni-containing material, the Co-containing material, and the Mn-containing material. For example, the first solvent may be an alcohol-based solvent. Specific examples of the first solvent include methanol, ethanol, propanol, butanol, and the like. However, any suitable solvent may be used.

In order for the Ni-containing material, the Co-containing material, and the Mn-containing material to be more uniformly mixed with the first solvent, they may be mixed together with mill balls while stirring. The mill balls may include any material that does not react with the Ni-containing material, the Co-containing material, the Mn-containing material, and the first solvent. For example, the mill balls may include ZrO₂ mill balls. However, any suitable mill balls may be used. In preparing the first mixture, the mixing rate may be from about 50 rpm to about 200 rpm. For example, the mixing rate may be from about 80 rpm to about 100 rpm. However, the mixing rate may vary depending on the kinds, amounts, and particle diameters of the Ni-containing material, Co-containing material, Mn-containing material, and the first solvent. In preparing the first mixture, the mixing time may be from about 12 hours to about 48 hours. For example, the mixing time may be from about 18 hours to about 24 hours. However, the mixing time may be appropriately varied.

A mixing ratio of the Ni-containing material, the Co-containing material, and the Mn-containing material may be appropriately selected to meet the ranges of p, q, and r defined above in conjunction with Formula 1.

After the first solvent is removed from the first mixture, a Li-containing material may be added to obtain the second mixture. The first solvent may be removed by thermally treating the first mixture. The thermal treatment temperature and time of the first mixture may be appropriately selected with the ranges in which the first solvent may be removed.

For example, if the first solvent is an alcohol, the thermal treatment temperature of the first mixture may be from about 100° C. to about 180° C. For example, the thermal treatment temperature of the first mixture may be from about 120° C. to about 150° C.

After the removal of the first solvent and before the addition of the Li-containing material, a resulting product may be ground to an average particle diameter of about 5 μm to about 10 μm.

Examples of the Li-containing material include: lithium hydroxides, such as LiOH and LiOH.H₂O; lithium carbonates; lithium nitrides; lithium halides; and carboxylic acid lithium salts, such as lithium acetate. A combination of at least two of these examples may also be used.

In order for the first mixture from which the first solvent has been removed to be more uniformly mixed with the Li-containing material, any of a variety of methods may be used. For example, mill balls may be added as described above.

The amount of the Li-containing material mixed with the first mixture from which the first solvent has been removed may be appropriately selected to meet the ranges of x and p+q+r defined above in conjunction with Formula 1.

The obtained second mixture is thermally treated so as to facilitate growth of particles in the second mixture, thereby yielding the positive active material of Formula 1 above in the form of single particles.

The thermal treating of the second mixture may be performed at a temperature of about 800° C. to about 1000° C. (for example, at a temperature of about 850° C. to about 950° C.) for about 10 hours to about 15 hours (for example, for about 10 hours to about 12 hours). However, the thermal treating of the second mixture may be performed at any appropriate temperature for any appropriate duration. The thermal treating of the second mixture may be performed under atmospheric or oxygen-atmosphere conditions.

When the thermal treatment temperature and time of the second mixture are within these ranges, the positive active material may have appropriate specific surface areas, and thus may ensure good stability and substantially zero load characteristics of a lithium battery.

In the thermal treating of the second mixture, the temperature of the second mixture may be increased at a temperature ramp rate of about 1° C./min to about 5° C./min to a target treatment temperature of, for example, about 800° C. to about 1000° C. For example, the temperature ramp rate may be from about 3° C./min to about 5° C./min. When the temperature ramp rate is within these ranges, a sufficient amount of calories may be supplied for uniform growth of particles, and thus may facilitate the formation of single particles.

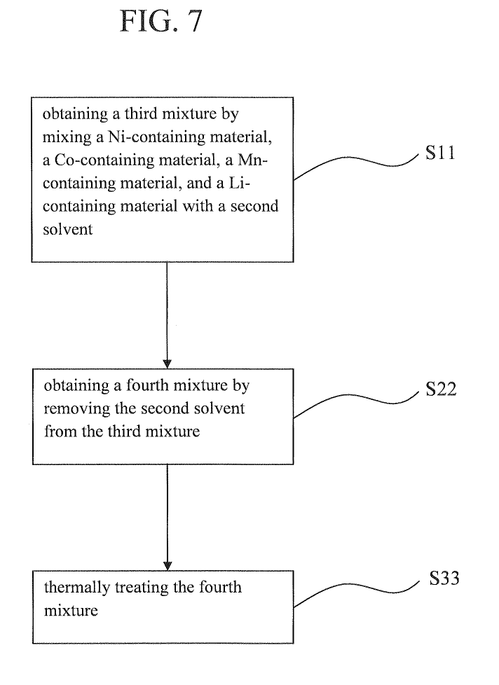

As shown in FIG. 7, a method of preparing the positive active material according to another embodiment of the present invention may include (S11) obtaining a third mixture by mixing a Ni-containing material, a Co-containing material, a Mn-containing material, and a Li-containing material with a second solvent; (S22) obtaining a fourth mixture by removing the second solvent from the third mixture; and (S33) thermally treating the fourth mixture. In the current embodiment the Ni-containing material, the Co-containing material, the Mn-containing material, and the Li-containing material are equivalent to those described in the previous embodiments, so a detailed description thereof will not be recited here. The second solvent corresponds to the first solvent of the previous embodiment of FIG. 6. The thermal treating of the fourth mixture corresponds to the thermal treating of the second mixture. Therefore, detailed descriptions thereof will not be repeated here. The current embodiment differs from the previous embodiment in terms of the order in which the Li-containing material is added.

The positive active material represented by Formula 1 in the form of single particles may be used in a positive electrode of a lithium battery. Thus, according to an embodiment of the present invention, a lithium battery includes: a positive electrode containing the positive active material; a negative electrode; and an electrolyte.

The positive electrode may include a current collector and a positive active material layer.

The positive active material layer may include the positive active material represented by Formula 1 above in the form of single particles. The positive active material has already been described above in detail, so a detailed description thereof will not be repeated here.

The positive active material layer may further include a first compound (lithiated intercalation compound) which allows reversible intercalation and deintercalation of lithium ions, in addition to the positive active material represented by Formula 1 in the form of single particles. Examples of the first compound include compounds represented by the following formulae:

LiₐA_{1-b}X_{b}D₂ (wherein 0.95≦a≦1.1, and 0≦b≦0.5); LiₐE_{1-b}X_{b}O_{2-c}D_{c} (wherein 0.95≦a≦1.1, 0≦b≦0.5, and 0≦c≦0.05); LiE_{2-b}X_{b}O_{4-c}D_{c} (wherein 0≦b≦0.5, and 0≦c≦0.05); LiₐNi_{1-b-c}Co_{b}BcD_{α} (wherein 0.95≦a≦1.1, 0≦b≦0.5, 0≦c≦0.05, and 0<α≦2); LiₐNi_{1-b-c}Co_{b}X_{c}O_{2-α}M_{α} (wherein 0.95≦a≦1.1, 0≦b≦0.5, 0≦c≦0.05, and 0<α<2); LiₐNi_{1-b-c}Co_{b}X_{c}O_{2-α}M₂ (wherein 0.95≦a≦1.1, 0≦b≦0.5, 0≦c≦0.05, and 0<α<2); LiₐNi_{1-b-c}Mn_{b}X_{c}D_{α} (wherein 0.95≦a≦1.1, 0≦b≦0.5, 0≦c≦0.05, and 0<α≦2); LiₐNi_{1-b-c}Mn_{b}X_{c}O_{2-α}M_{α} (wherein 0.95≦a≦1.1, 0≦b≦0.5, 0≦c≦0.05, and 0<α<2); LiₐNi_{1-b-c}Mn_{b}X_{c}O_{2-α}M₂ (wherein 0.95≦a≦1.1, 0≦b≦0.5, 0≦c≦0.05, and 0<α<2); LiₐNi_{b}E_{c}G_{d}O₂ (wherein 0.90≦a≦1.1, 0≦b≦0.9, 0≦c≦0.5, and 0.001≦d≦0.1); LiₐNi_{b}Co_{c}Mn_{d}GₑO₂ (wherein 0.90≦a≦1.1, 0≦b≦0.9, 0≦c≦0.5, 0≦d≦0.5, and 0≦e≦0.1); LiₐNiG_{b}O₂ (wherein 0.90≦a≦1.1, and 0.001≦b≦0.1); LiₐCoG_{b}O₂ (wherein 0.90≦a≦1.1, and 0.001≦b≦0.1); LiₐMnG_{b}O₂ (wherein 0.90≦a≦1.1, and 0.001≦b≦0.1); LiₐMn₂G_{b}O₄ (wherein 0.90≦a≦1.1, and 0≦b≦0.1); QO₂; QS₂; LiQS₂; V₂O₅; LiV₂O₅; LiZO₂; LiNiVO₄; Li_{(3-f)}J₂(PO₄)₃ (wherein 0≦f≦2); Li_{(3-f)}Fe₂(PO₄)₃ (wherein 0≦f≦2); LiFePO₄; and lithium titanate.

In the above formulae, A may be selected from the group consisting of nickel (Ni), cobalt (Co), manganese (Mn), and combinations thereof; X is selected from the group consisting of aluminum (Al), nickel (Ni), cobalt (Co), manganese (Mn), chromium (Cr), iron (Fe), magnesium (Mg), strontium (Sr), vanadium (V), a rare earth element, and combinations thereof; D may be selected from the group consisting of oxygen (O), fluorine (F), sulfur (S), phosphorus (P), and combinations thereof; E is selected from the group consisting of cobalt (Co), manganese (Mn), and combinations thereof; M may be selected from the group consisting of fluorine (F), sulfur (S), phosphorus (P), and combinations thereof; G may be selected from the group consisting of aluminum (Al), chromium (Cr), manganese (Mn), iron (Fe), magnesium (Mg), lanthanum (La), cerium (Ce), strontium (Sr), vanadium (V), and combinations thereof; Q may be selected from the group consisting of titanium (Ti), molybdenum (Mo), manganese (Mn), and combinations thereof; Z is selected from the group consisting of chromium (Cr), vanadium (V), iron (Fe), scandium (Sc), yttrium (Y), and combinations thereof; and J may be selected from the group consisting of vanadium (V), chromium (Cr), manganese (Mn), cobalt (Co), nickel (Ni), copper (Cu), and combinations thereof.

The positive active material layer may further include a binder.

The binder strongly binds positive active material particles to each other and to a current collector. Examples of the binder include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon, but are not limited thereto.

Al or Cu may be used to form the current collector, but aspects of the present invention are not limited thereto.

The positive active material layer may be formed by coating a positive active material composition on the current collector, wherein the positive active material composition is prepared by mixing the positive active material and the binder (and optionally further mixing the conductive agent) in a solvent. The method of manufacturing the positive electrode is well known to one of ordinary skill in the art, and thus a detailed description thereof will not be provided. N-methylpyrrolidione may be used as the solvent, but the present invention is not limited thereto.

The negative electrode may include a negative active material layer and a current collector.

Natural graphite, a silicon/carbon complex, silicon oxide (SiOₓ), silicon metal, silicon thin film, lithium metal, a lithium alloy, a carbonaceous material or graphite may be used as the negative active material. For example, the lithium alloy may be a lithium titanate. Examples of the lithium titanate include spinel-structured lithium titanate, anatase-structured lithium titanate, and ramsdellite-structured lithium titanate, which are classified according to their crystal structures. For example, the negative active material may be Li₄₋ₓTi₅O₁₂ (0≦x≦3). For another example, the negative active material may be Li₄Ti₅O₁₂. However, any suitable material may be used.

A binder and a solvent used in a negative active material composition may be the same as those used in the positive active material composition. A conductive agent that may be optionally added to the negative active material layer composition may include at least one material selected from the group consisting of carbon black, ketjen black, acetylene black, artificial graphite, natural graphite, copper powder, nickel powder, aluminum powder, silver powder, and polyphenylene.

A plasticizer may be further added to the positive active material composition and the negative active material composition in order to induce pores in the electrode plates.

The electrolyte may include a nonaqueous organic solvent and a lithium salt.

The nonaqueous organic solvent may function as a migration medium of ions involved in electrochemical reactions in batteries.

Examples of the nonaqueous organic solvent include carbonates, esters, ethers, ketones, alcohols, and aprotic solvents. Examples of the carbonates available as the nonaqueous organic solvent include dimethyl carbonate (DMC), diethyl carbonate (DEC), dipropyl carbonate (DPC), methylpropyl carbonate (MPC), ethylpropyl carbonate (EPC), ethyl methyl carbonate (EMC), ethylene carbonate (EC), propylene carbonate (PC), and butylene carbonate (BC). Examples of the esters available as the nonaqueous organic solvents include methyl acetate, ethyl acetate, n-propyl acetate, dimethyl acetate, methyl propionate, ethyl propionate, γ-butyrrolactone, decanolide, valerolactone, mevalonolactone, and caprolactone. Examples of the ethers available as the nonaqueous organic solvent include dibutyl ether, tetraglyme, diglyme, dimethoxyethane, 2-methyltetrahydrofuran, and tetrahydrofuran. An example of the ketones available as the nonaqueous organic solvent is cyclohexanone. Examples of the alcohols available as the nonaqueous organic solvent include ethyl alcohol, isopropyl alcohol, and the like. Examples of the aprotic solvents include nitrils, such as R-CN (wherein R is a linear, branched or cyclic C2-C20 hydrocarbon group, which may have a double bond, an aromatic ring or an ether bond); amides, such as dimethylformamide; dioxoranes, such as 1,3-dioxolane; and sulfolanes.

The nonaqueous organic solvent may be used alone. Alternatively, at least two of the nonaqueous organic solvents may be used in combination. In this case, a mixing ratio of the at least two nonaqueous organic solvents may appropriately vary according to the desired performance of the battery, which is obvious to one of ordinary skill in the art.

The lithium salt is dissolved in the organic solvent and operates as a source of lithium ions in the battery, thereby enabling the basic operation of the battery. In addition, the lithium salt facilitates the migration of lithium ions between the positive electrode and the negative electrode. Examples of the lithium salt include at least one supporting electrolyte salt selected from the group consisting of LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) (wherein x and y are natural numbers), LiCl, LiI, and LiB(C₂O₄)₂ (LiBOB: lithium bis(oxalato) borate). The concentration of the lithium salt may be in the range of about 0.1 to about 2.0 M. When the concentration of the lithium salt is within this range, the electrolyte may have an appropriate conductivity and viscosity, and thus may exhibit excellent performance and allow lithium ions to effectively migrate.

A separator may be disposed between the positive electrode and the negative electrode according to the type of the lithium battery. The separator may be a monolayer or a multilayer including at least two layers of polyethylene, polypropylene, polyvinylidene fluoride, or a combination thereof. For example, the separator may be a two-layered separator including polyethylene and polypropylene layers, a three-layered separator including polyethylene, polypropylene and polyethylene layers, or a three-layered separator including polypropylene, polyethylene and polypropylene layers.

Lithium batteries may be classified as lithium ion batteries, lithium ion polymer batteries, or lithium polymer batteries, according to the type of separator and/or electrolyte included therein. In addition, lithium batteries may be classified as cylindrical, rectangular, coin-type, or pouch-type, according to the shape thereof. Lithium batteries may also be classified as bulk-type and thin-film type, according to the size thereof. Lithium batteries may be used either as primary lithium batteries or secondary lithium batteries. A method of manufacturing a lithium battery is widely known in the field, so a detailed description thereof will not be recited here.

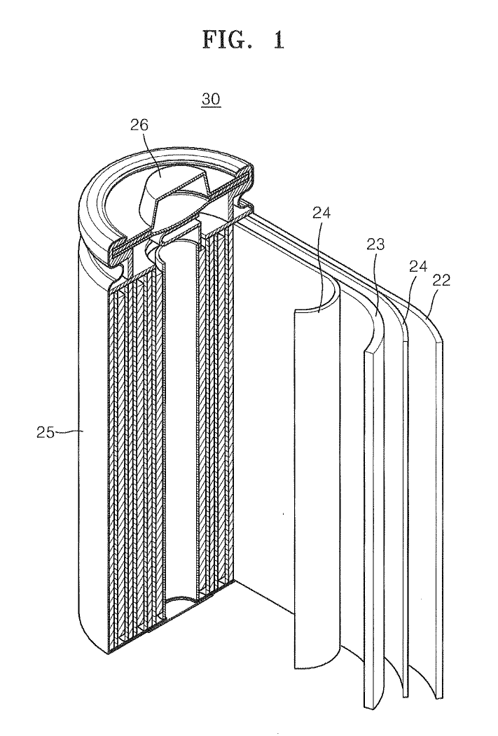

FIG. 1 is a schematic perspective view of a lithium battery 30 constructed as an embodiment of the present invention. Referring to FIG. 1, the lithium battery 30 includes an electrode assembly having a positive electrode 23, a negative electrode 22, and a separator 24 between the positive electrode 23 and the negative electrode 22. The electrode assembly is contained within a battery case 25, and a sealing member 26 seals the battery case 25. An electrolyte (not shown) is injected into the battery case 25 to impregnate the electrolyte assembly. The lithium battery 30 is manufactured by sequentially stacking the positive electrode 23, the negative electrode 22, and the separator 24 on one another to form a stack, rolling the stack into a spiral form, and inserting the rolled up stack into the battery case 25.

Hereinafter, one or more embodiments of the present invention will be described in further detail with reference to the following examples. These examples are not intended to limit the purpose and scope of the one or more embodiments of the present invention.

### EXAMPLE 1

NiO₂ (having an average particle diameter of about 6 μm), Co₃O₄ (having an average particle diameter of about 6 μm), and MnO₂ (having an average particle diameter of about 6 μm) were mixed in a molar ratio of Ni:Co:Mn of 0.5:0.2:0.3, and were then placed in a ball mill container containing ZrO₂ balls, followed by an addition of ethanol thereto. After mixing the mixture at 100 rpm for 24 hours, the ZrO₂ balls were removed, and the remaining mixture was dried in an oven at 120° C. The resulting product was ground to an average particle diameter of about 6 μm by using sieving equipment. Then, Li₂CO₃ was added thereto in a molar ratio of Li to the mixture of Ni, Co, and Mn of 1.03:1, and then mixed using a basic mixer. The resulting mixture was placed in a sintering container. The temperature was raised at a rate of about 5° C./min up to about 900° C., and the mixture was thermally treated at that temperature for about 12 hours to obtain a positive active material.

The positive active material was surface-treated with ammonium hexafluoroaluminate and then observed using a scanning electron microscope (SEM). The results are shown in FIGS. 1 and 2 (respectively, 50× and 10,000× magnifications). FIGS. 1 and 2 show that the positive active material is in the form of single particles.

### EXAMPLE 2

NiO₂ (having an average particle diameter of about 6 μm), Co₃O₄ (having an average particle diameter of about 6 μm), MnO₂ (having an average particle diameter of about 6 μm), and Li₂CO₃ (having an average particle diameter of about 6 μm) were mixed in a molar ratio of Ni:Co:Mn of 0.5:0.2:0.3 and a molar ratio of Li to the mixture of Ni, Co, and Mn of 1.03:1, and then placed in a ball mill container containing ZrO₂ balls, followed by addition of ethanol thereto. After mixing the mixture at 100 rpm for 24 hours, the ZrO₂ balls were removed, and the remaining mixture was dried in an oven at 120° C. The resulting product was ground to an average particle diameter of about 6 μm by using sieving equipment. The resulting mixture was placed in a sintering container. The temperature was raised at a rate of about 5° C./min up to about 900° C., and the mixture was thermally treated at that temperature for about 12 hours to obtain a positive active material.

### EXAMPLE 3

NiO₂ (having an average particle diameter of about 6 μm), CO₃O₄ (having an average particle diameter of about 6 μm), MnCO₃ (having an average particle diameter of about 6 μm), and Li₂CO₃ (having an average particle diameter of about 6 μm) were mixed in a molar ratio of Ni:Co:Mn of 0.5:0.2:0.3 and a molar ratio of Li to the mixture of Ni, Co, and Mn of 1.03:1, and then placed in a ball mill container containing ZrO₂ balls, followed by addition of ethanol thereto. After mixing the mixture at 100 rpm for 24 hours, the ZrO₂ balls were removed, and the remaining mixture was dried in an oven at 120° C. The resulting product was ground to an average particle diameter of about 6 μm by using sieving equipment. The resulting mixture was placed in a sintering container. The temperature was raised at a rate of about 5° C./min up to about 900° C., and the mixture was thermally treated at that temperature for about 12 hours to obtain a positive active material.

### COMPARATIVE EXAMPLE 1

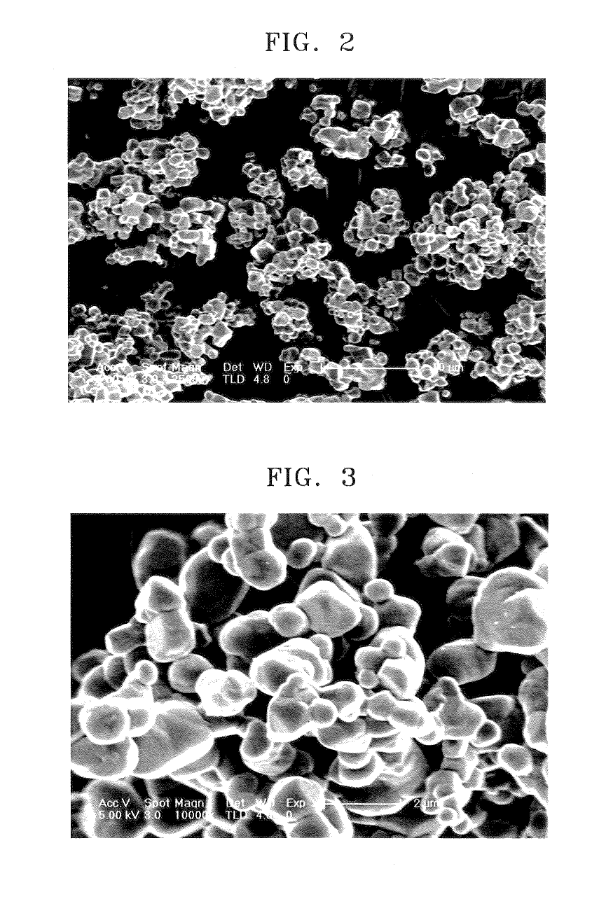

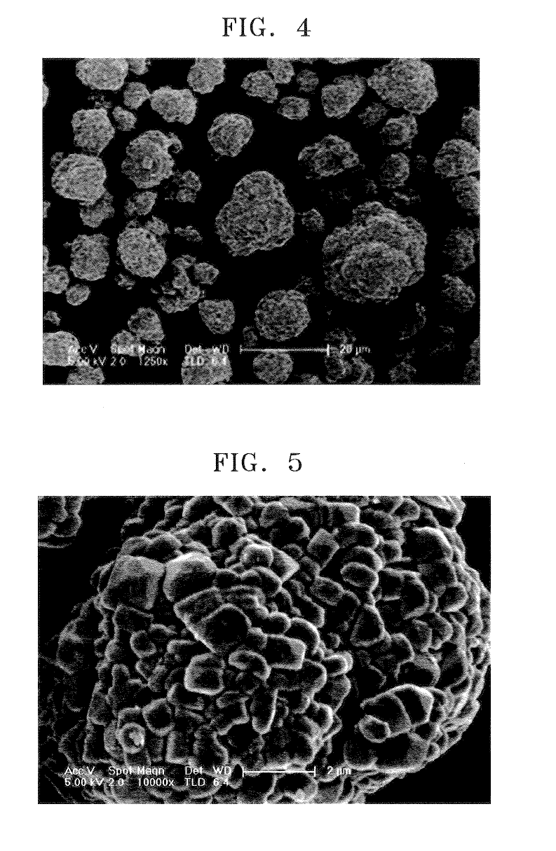

A LiNi_{0.5}CO_{0.2}Mn_{0.3}O₂ positive active material in the form of secondary particles (synthesized by co-precipitation) was prepared. The LiNi_{0.5}Co_{0.2}Mn_{0.3}O₂ positive active material in the form of secondary particles was surface-treated with ammonium hexafluoroaluminate and then observed using a scanning electron microscope (SEM). The results are shown in FIGS. 3 and 4 (respectively, 50× and 10,000× magnifications). Referring to FIGS. 3 and 4, it is clear that the LiNi_{0.5}Co_{0.2}Mn_{0.3}O₂ positive active material includes agglomerates from multiple primary particles.

As described above, according to the one or more of the above embodiments of the present invention, a positive active material may be in the form of single particles and may have good electrochemical characteristics due to Ni, Mn and Co being included.

While the present invention has been described in connection with exemplary embodiments thereof, it will be understood by those of ordinary skill in the art that various modifications may be made to the described embodiments without departing from the spirit and scope of the present invention, as defined by the appended claims.

What is claimed is:

1. A positive active material, comprising:
single particles of the positive active material each being represented by
Liₓ(NiₚCo_{q}Mnᵣ)O_{y}, Formula 1
wherein, in Formula 1, 0.95≦x≦1.05, 0<p<1, 0<q<1, 0<r<1, p+q+r=1 and 0<y≦2.025.

2. The positive active material of claim 1 comprised of the single particles, having an average particle diameter (D₅₀) of about 5 μm to about 10 μm.

3. The positive active material of claim 1 comprised of the single particles, having a surface area of about 0.23 m²/g or less.

4. The positive active material of claim 1, wherein, in Formula 1, x=1, p=0.5, q=0.2, r=0.3, and y=2; x=1.05, p=0.6, q=0.2, r=0.2, and y=2; or x=1.03, p=0.5, q=0.2, r=0.3, and y=2.

5. A method of preparing a positive active material, the method comprising:
obtaining a first mixture by mixing a Ni-containing material, a Co-containing material, and a Mn-containing material with a first solvent;
obtaining a second mixture by removing the first solvent from the first mixture and adding a Li-containing material to the first mixture; and
thermally treating the second mixture.

6. The method of claim 5, wherein the Ni-containing material comprises at least one compound selected from the group consisting of nickel oxides, nickel hydroxides, nickel carbonates, nickel nitrides, nickel sulfides, nickel halides, and carboxylic acid nickel salts;
the Co-containing material comprises at least one compound selected from the group consisting of cobalt oxides, cobalt hydroxides, cobalt halides, and carboxylic acid cobalt salts; and
the Mn-containing compound comprises at least one compound selected from the group consisting of manganese oxides, manganese carbonates, manganese nitrides, manganese sulfides, manganese halides, and carboxylic acid manganese salts.

7. The method of claim 5, wherein the first solvent comprises an alcohol-based solvent.

8. The method of claim 5, wherein the thermal treating of the second mixture is performed at a temperature of about 800° C. to about 1000° C.

9. The method of claim 5, wherein the thermal treating of the second mixture is performed for a duration of about 10 hours to about 15 hours.

10. A method of preparing a positive active material, the method comprising:
obtaining a third mixture by mixing a nickel (Ni)-containing material, a cobalt (Co)-containing material, a manganese (Mn)-containing material, and a lithium (Li)-containing material with a second solvent;
obtaining a fourth mixture by removing the second solvent from the third mixture; and
subjecting the fourth mixture to thermal treatment.

11. The method of claim 10, wherein the Ni-containing material comprises at least one compound selected from the group consisting of nickel oxides, nickel hydroxides, nickel carbonates, nickel nitrides, nickel sulfides, nickel halides, and carboxylic acid nickel salts;
the Co-containing material comprises at least one compound selected from the group consisting of cobalt oxides, cobalt hydroxides, cobalt halides, and carboxylic acid cobalt salts; and
the Mn-containing compound comprises at least one compound selected from the group consisting of manganese oxides, manganese carbonates, manganese nitrides, manganese sulfides, manganese halides, and carboxylic acid manganese salts.

12. The method of claim 10, wherein the second solvent comprises an alcohol-based solvent.

13. The method of claim 10, wherein the thermal treatment of the fourth mixture is performed at a temperature of about 800° C. to about 1000° C.

14. The method of claim 10, wherein the thermal treatment of the fourth mixture is performed for a duration of about 10 hours to about 15 hours.

15. A lithium battery, comprising:
a positive electrode comprising a positive active material comprised of single particles each being represented by Formula 1;
a negative electrode; and
an electrolyte imposed between the positive and negative electrodes, wherein
Formula 1 is
Liₓ(NiₚCo_{q}Mnᵣ)O_{y},
wherein in Formula 1, 0.95≦x≦1.05, 0<p<1, 0<q<1, 0<r<1, p+q+r=1, and 0<y≦2.025.

16. The lithium battery of claim 15, wherein the positive active material has an average particle diameter (D₅₀) of about 5 μm to about 10 μm.

17. The lithium battery of claim 15, wherein the positive active material has a surface area of about 0.23 m²/g or less.

18. The lithium battery of claim 15, wherein, in Formula 1, x=1, p=0.5, q=0.2, r=0.3, and y=2; x=1.05, p=0.6, q=0.2, r=0.2, and y=2; or x=1.03, p=0.5, q=0.2, r=0.3, and y=2.
